(19) United States
(12) Patent Application Publication
(10) Pub. No.: US 2010/0316855 A1
(43) Pub. Date: Dec. 16, 2010

(54) METHOD FOR MAKING A PACKAGING MATERIAL, IN PARTICULAR FOR A CONTAINER FOR A COSMETIC OR CARE PRODUCT OR FOR A DISPLAY RACK, METHOD FOR PRODUCING A CASE AND CORRESPONDING PACKAGING MATERIAL

(75) Inventor: Alain Bethune, Savigny-sur-Orge (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: L'OREAL, Paris (FR)

(21) Appl. No.: 12/809,253

(22) PCT Filed: Dec. 17, 2008
(86) PCT No.: PCT/FR2008/052342

§ 371 Date: Aug. 24, 2010

Related U.S. Application Data
(60) Provisional application No. 61/024,408, filed on Jan. 29, 2008.

(30) Foreign Application Priority Data
Dec. 19, 2007 (FR) 0760033

(51) Int. Cl. B32B 3/10; B32B 37/12; B32B 37/16; B32B 38/14; B32B 29/00

(52) U.S. Cl. 428/211.1; 156/277; 156/242; 156/250; 428/195.1

(57) ABSTRACT

This method for making a packaging material for preparing cases, notably packaging for containers for storing and distributing cosmetic or care product, or for producing displays, which comprises steps of:
taking a thermoplastic film from a supply reel;
printing the film on at least one of its faces so as to produce, for each case, a polychrome pattern; and
depositing the printed film on a support in sheet form by gluing.

The invention relates, in a general manner, to the production of cases, notably for containers for storing and distributing a cosmetic or care product, or for placards for displays on the place of sale.

A “cosmetic or care product” is understood to mean a product as defined in Counsel Directive 93/35/EEC of 13 Jun. 1993.

Traditionally, packaging, in particular cardboard packaging, is made from offset printed cardboard sheets that are cut out, glued and then made up into a case.

With the aim of improving the surface state of the cardboard and of giving the packaging a shiny appearance, cardboard sheets are, after printing, varnished or covered with a laminating film. A gilding press may also be used for depositing a gilded block pattern by hot stamping.

Generally, the number of colors to be printed is greater than the number of stations of the offset printing machine and of complementary printing techniques.

It is therefore necessary to perform several consecutive printing operations in order to print all the colors. Printing cardboard in sheet form thus takes a relatively long time. In any case, it requires specific printing machines that are not widespread. Moreover, when a varnish is deposited on printed cardboard with the aim of giving the packaging an ultra gloss appearance, the varnish is generally deposited at a high temperature, for example of the order of 115° in a humid atmosphere that brings about relatively high energy consumption and requires the use of a high quality cardboard compatible with the humid environment coupled with a high temperature of approximately 115° C.

It will be noted in this respect that hot stamping remains fragile since it is deposited on the surface.

It is also known, in the state of the art, to preprint plastic film, for example by offset, and to glue the printed film onto cardboard taken continuously from a reel supplying cardboard, the cardboard covered in this way with printed film being then cut up, glued and shaped in order to produce a final case.

This technique also has a certain number of disadvantages, in as much as the case blank is generally bowed by reason of the fact that the cardboard from which it is prepared is rolled in a reel. This bowing phenomenon appears to an increased extent as the reel unwinds, taking into account the reduction in radius of the reel and the consequent increase in the curvature of the cardboard in the reel. This phenomenon produces relatively high amounts of waste, portions that are nearest to the mandrel of the reel being generally unused. Forming such cases is difficult to perform mechanically, given the bowing of the blank.

In this respect, reference may be made to document US 2007/0196603 that describes such a technique for producing a case.

As may be imagined, traditional techniques for producing a case, notably of cardboard, present a certain number of major disadvantages relating either to the fact that they require specific machines, a printing phase that takes a relatively long time and requires cardboard of increased quality, or to the fact that they produce relatively large numbers of rejects.

Moreover, when the cardboard is taken from a supply reel, problems may occur of adjusting the position of the cardboard.

It will finally be noted that, when it is desired to obtain a satin visual effect and to give a particular tactile impression, it is necessary to use thermal varnishes, for example of the acrylic type, which may only be applied to cardboard by means of specific machines having suitable drying devices.

In view of the preceding account, a need exists for having a method available for producing a packaging material, for example made of cardboard, which remedies all or part of the disadvantages of the state of the art and, in particular, a method for producing a packaging material in which the printing operation is facilitated, in which it is possible to use a poorer quality cardboard, for example coming from post-consumer recycles, and in which cardboard rejects are reduced or even eliminated.

The subject of the invention is therefore, according to a first feature, a method for making a packaging material for preparing cases, notably packaging for containers for storing and distributing a cosmetic or care product, or for producing displays, which comprises steps of:
taking a thermoplastic film from a supply reel;
printing the film on at least one of its faces so as to produce, for each case, a polychrome pattern; and
depositing the printed film on a support in sheet form by gluing.

Thus, by means of printing patterns, not on cardboard but on a thermoplastic film, it is possible to use conventional printing techniques and therefore relatively widespread printing machines.

Moreover, by means of depositing the film on a support in sheet form, rejects produced are eliminated when the support is taken from a reel.

It will finally be noted that since ink printing is carried out on the thermoplastic film and not on cardboard, it is possible to use lower quality cardboard with inferior mechanical rigidity compensated for by the provision of a film.

According to another feature of the method according to the invention, the film is made of a material that is transparent to light and is printed on its face designed to be applied to the support.

In this way a very shiny effect is obtained and in-depth printing of patterns, which were traditionally obtained by depositing a relatively costly calendered varnish.

According to yet another feature, the method additionally includes a step of embossing the support.

It will be noted that the support is advantageously made of cardboard in sheet form.

The cardboard may be cardboard chosen from a cellulose-based cardboard, a chrome coated cardboard, a wood-based cardboard or a GT quality cardboard.

For example, the thickness of the cardboard is between approximately 300 and approximately 600 microns.

According to another feature of the method, the film is deposited continuously on juxtaposed cardboard sheets supplied continuously. A step is then also provided for cutting the plastic film between the cardboard sheets.

Each cardboard sheet may be rectangular, with a length between approximately 60 cm and approximately 140 cm, and with a width between approximately 40 cm and approximately 100 cm.

As regards the film, this may be a film formed partly of a composition comprising at least one polymer chosen from cellulose acetate, polyethylene terephthalate (PET), polypropylene (PP), biaxially oriented polypropylene (BOPP) and lactic polyacid (LPA).

The thickness of this film may be between approximately 10 microns and 50 microns, preferably between 12 and 36 microns.

According to one embodiment, the film is a self-adhesive film, notably a film coated with an adhesive based on an acrylic glue.

The film may be, in another embodiment, adhered by means of a water-based glue or a hot melt glue.

According to another feature of the invention, the printing step comprises successive steps of depositing a colored ink.

It may moreover include a step of depositing at least one ink filled with metal particles, subsequent to the steps of depositing a colored ink.

In this case, a colored translucent varnish layer may be deposited prior to depositing an ink filled with metal particles.

The varnish is then dried before depositing the ink filled with metal particles.

It is furthermore possible to print a locating pattern during printing for the purpose of indexing a subsequent cutting step.

According to another feature, the subject of the invention is also a method for producing cases, notably as a container for storing and distributing a cosmetic or care product, comprising steps of:
taking a thermoplastic film from a supply reel;
printing the film on at least one of its faces so as to produce, for each case, a polychrome pattern;
depositing the printed film on a support in sheet form by gluing;
cutting up the support covered with the printed film; and
preparing each case.

The subject of the invention is furthermore, according to another feature, a packaging material for producing cases, notably as a container for storing and distributing a cosmetic or care product or for the production of displays, comprising a sheet of base material covered with a thermoplastic film printed with polychrome patterns formed by printing said film.

According to another feature of this material, the material is based on cardboard.

As regards the film, this is a transparent thermoplastic film, the printed face of the film being turned toward the base material sheet.

It contains for example UV filters that enable inks to be light-fast and to prevent yellowing of the support if it is white.

Other objects, features and advantages of the invention will become apparent on reading the following description, given solely by way of a non-limiting example, made with reference to the appended drawings, in which:

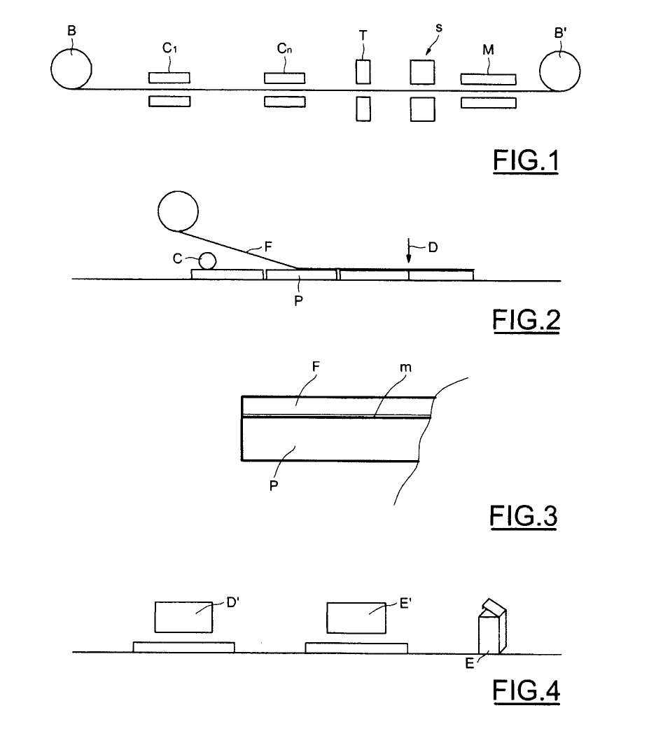

FIG. 1 is a schematic side view of an installation for printing a thermoplastic film;

FIG. 2 is a schematic side view of an installation for gluing a printed thermoplastic film on cardboard sheets;

FIG. 3 is a schematic sectional view of a packaging material obtained by means of the installation of FIG. 2; and

FIG. 4 illustrates an installation for forming a case from cardboard sheets made by means of the installation of FIG. 2.

With reference to FIGS. 1 and 2, a description will now be given of the principal steps of a method for producing a packaging material for the production of cases for a cosmetic or care product.

In the embodiment envisaged, the packaging material is based on cardboard.

However, it will be noted that there is no departure from the scope of the invention when use is made of any other type of suitable material instead of cardboard for the use envisaged.

However, in the embodiment envisaged, the packaging material consists of cardboard sheets P covered with a film F made of pre-printed thermoplastic material.

In as much as printing is carried out on thermoplastic film and not directly on cardboard, it is possible to use poorer quality cardboards than if printing were carried out directly on cardboard.

Thus, for example, use is made either of pure cellulose-based cardboard, SBS quality cardboard, chrome-coated cardboard, GGZ quality cardboard, wood-based cardboard, for example all wood cardboard of GC quality, or GT quality, for example recycled cardboard with good surface smoothness.

However, any other type of cardboard may also be used, a wide choice of qualities being permitted by virtue of printing being carried out on thermoplastic film.

It will also be noted that the thermoplastic film, glued onto the cardboard sheet, increases the rigidity of the cardboard so that use may be made of cardboards having a thickness and weight reduced by the order of 5 to 10%, as compared with techniques for printing on cardboard.

In this respect, use may be made for example of cardboards with a thickness between 300 to 600 microns according to the weight of the packaging container.

As regards the thermoplastic film, use will preferably be made of a translucent thermoplastic film, printing being carried out on the face designed to be applied against the cardboard sheets P, which makes it possible to protect the printing against external attack and obtain depth and brilliance of colors, while avoiding the need to provide an expensive calendered varnish.

It will be possible, for example, to use a thermoplastic film formed from a composition comprising at least one polymer chosen from polyethylene terephthalate (PET), polypropylene (PP), biaxially oriented polypropylene (BOPP) and lactic polyacid (LPA).

It will be noted however that cellulose acetate and BOPP are advantageous in that they enable a very transparent film to be obtained, LPA being advantageous by reason of its biodegradability.

With reference to FIG. 1, the film F is printed by means of an installation comprising an assembly of successive stations, each providing one of the printing operations.

The film is taken from a reel B, containing for example a film having a length of 2000 to 4000 m and a thickness of between 10 and 50 microns, preferably between 12 and 36 microns.

As previously indicated, it is printed on one of its faces designed to be applied against the sheets P.

It will however be noted that it is also possible, as a variant, to provide printing of two mutually opposed faces of the film, according to the visual impression that is to be given to the finished product.

The installation that may be seen in FIG. 1 comprises several printing stations Cl, . . . , Cn, each printing one color. After printing, the printed film is rolled around a receiving reel B′.

If desired, according to the nature of the patterns to be produced, it is possible as illustrated to provide downstream printing stations Cl, . . . , Cn, additional stations depositing ink filled with metal particles in order to give the finished product a metallic appearance, for example, a silver or gold effect.

A station M will thus be provided downstream of the printing stations, Cl, . . . , Cn, serving to deposit a metalized ink, for example ink based on aluminum, platinum or magnesium particles.

However, if the metalized appearance that is to be given to the finished packaging is gold or colored, a transparent ink colored by means of a printing station T situated downstream of the printing stations Cl, . . . , Cn will be deposited on the printed film, prior to deposition of the metalized ink.

A drying station S will be provided upstream of the metalizing station M for drying the varnish prior to deposition of the metalized ink.

It will be possible, in this respect, either to use infrared drying so as to dry by heat, or to use a UV drying station, so as to dry by crosslinking.

As regards the printing stations Cl, . . . , Cn for printing colors on the film F, various types of printing technique may be used.

It will be possible in this respect to use flexography or photogravure, particularly suitable for long printing runs for which high rendering quality is required, or screen printing which allows strong ink deposits to be made and in this way guarantees an intense color and good opacity.

As regards the printing of a silver ink, a photogravure, flexography or preferably screen printing technique may also be used, which enable, as previously indicated, good metallic reproduction to be obtained by permitting a strong ink deposit.

Various types of ink may be used when printing.

It will be possible for example to use inks referenced Quicksilver™ SF 01 or SF 02 of the Xymara™ range from Ciba™ for flat screen printing.

The colored ink deposited at the station T may consist of a dye marketed by Ciba™ under the trade names Microlyte A™ or Orasol™.

It will however be noted that for gilding the film, it will be possible, instead of a deposit of metalized ink preceded by a deposit of colored transparent ink (station T) to use a method for film gilding, such as the technique known under the name “foil blocking” which consists of depositing a metalized film on the thermoplastic film.

As previously indicated, after printing, the film is rolled around a receiving reel B′.

With reference to FIG. 2, the film is then deposited continuously on juxtaposed sheets P that are fed continuously.

In one embodiment, the thermoplastic film may be a film of the self-adhesive type, that is to say previously coated with glue, for example of the acrylic type. However, as illustrated, it will be possible to provide, as a variant, a gluing station C capable of depositing a transparent glue, preferably a solventless glue, on the cardboard sheets.

It will possible, in this respect, to use either a water-based glue or a hot melt glue such as the glue marketed by Bostik™ under reference TLH 4191.

After deposition, the coated sheets of printed thermoplastic film are once again presented to a cutting station D on which the film is cut transversely, while taking account of the direction in which the sheets advance, at the upstream and downstream edges of the sheets. The film off-cuts between sheets are recycled.

In this way, an assembly of sheets P is obtained leaving the film gluing installation, each covered with a film F having an assembly of printed polychrome patterns m, each corresponding to a blank for the case to be made (FIG. 3).

It will be noted, in this respect that, for example, when the film is printed, a matrix of an assembly of polychrome patterns is produced simultaneously, for example a matrix of 1 to 36 patterns and preferably between 4 and 16 patterns, each corresponding to a case blank.

In this way, during a subsequent phase of the method, visible in FIG. 4, each sheet covered with the printed film is cut up (station D′) so as to separate the blanks from the sheets. In the case where the blanks are not all intended for making the same case, they are subsequently separated.

Gluing is then carried out (station E′) and the blanks are then made up so as to form a case E.

It will be noted that during these cutting, gluing and shaping steps, each blank is located by means of the presence of an indexing point constituting a locating pattern for positioning and orientating the blank in the cutting and gluing stations.

For example, this indexing pattern is made by one of the printing stations Cl, . . . , Cn.

1. A method for making a packaging material for preparing cases, or for producing displays, the method comprising the steps of:
taking a thermoplastic film from a supply reel;
printing the film on at least one of its faces so as to produce, for each case, a polychrome pattern; and
depositing the printed film on a support in sheet form by gluing,
wherein the film is made of a material that is transparent to light and is printed on its face designed to be applied against the support.

2. The method as claimed in claim 1, further comprising a step of:
embossing the support.

3. The method as claimed in claim 1, wherein the support is cardboard in sheet form.

4. The method as claimed in claim 3, wherein the cardboard is selected from the group consisting of a cellulose-based cardboard, a chrome coated cardboard, a wood-based cardboard, and a GT quality cardboard.

5. The method as claimed in claim 3 wherein the thickness of the cardboard is between approximately 300 microns and approximately 600 microns.

6. The method as claimed in claim 1, wherein the film is deposited continuously on juxtaposed cardboard sheets supplied continuously and
further comprises a step of:
cutting the plastic film in the cardboard sheets.

7. The method as claimed in claim 6, wherein each cardboard sheet is rectangular, with a length between approximately 60 cm and 140 cm, and with a width between approximately 40 cm and 100 cm.

8. The method as claimed in claim 1, wherein the thermoplastic film is a film formed from a composition comprising at least one polymer selected from the group consisting of cellulose acetate, polyethylene terephthalate (PET), polypropylene (PP), biaxially oriented polypropylene (BOPP), and lactic polyacid (LPA).

9. The method as claimed in claim 8, wherein the thickness of the film is between approximately 10 and 50 microns, preferably between 12 and 36 microns.

10. The method as claimed in claim 1, wherein the film is a self-adhesive film, such that the film is coated with an adhesive based on an acrylic glue.

11. The method as claimed in claim 1, wherein the film is glued by means of a water-based glue.

12. The method as claimed in claim 1, wherein the film is glued by a hot-melt glue.

13. The method as claimed in claim 1, wherein the printing step comprises successive steps of depositing a colored ink.

14. The method as claimed in claim 13, wherein the printing step further includes a step of depositing at least one ink filled with metal particles, subsequent to the steps of depositing a colored ink.

15. The method as claimed in claim 14, wherein a colored varnish layer is deposited prior to depositing an ink filled with metal particles.

16. The method as claimed in claim 15, wherein the varnish is dried before depositing the ink filled with metal particles.

17. The method as claimed in claim 1, wherein a locating pattern is printed during printing for the purpose of indexing a subsequent cutting step.

18. A method for making cases, the method comprising the steps of:
taking a translucent thermoplastic film from a supply reel;
printing the film on at least one of its faces so as to produce, for each case, a polychrome pattern;
depositing the printed film on a support in sheet form by gluing, the printed face of the film being turned toward the sheet support;
cutting up the support covered with the printed film; and
preparing each case.

19. A packaging material for producing containers for storing and distributing a cosmetic or care product or for producing displays, comprising:
a sheet of base material covered with a thermoplastic film printed with polychrome patterns formed by pre-printing said film, the film being a transparent thermoplastic film and the printed face of the film being turned toward the sheet of base material.

20. The material as claimed in claim 19, wherein the sheet of base material comprises cardboard.

21. The material as claimed in claim 19 wherein the film contains UV filters.

22. The method as claimed in claim 18, wherein a locating pattern is printed during printing for the purpose of indexing a subsequent cutting step.

23. The method as claimed in claim 4, wherein the thickness of the cardboard is between approximately 300 microns and approximately 600 microns.

24. The material as claimed in claim 20, wherein the film contains UV filters.
